(19) United States
(12) Patent Application Publication
(10) Pub. No.: US 2022/0380243 A1
(43) Pub. Date: Dec. 1, 2022

(54) DIRECT SOLVENT CONTACT CRYSTALLIZATION ZERO-LIQUID DISCHARGE DESALINATION WITH VOLATILE HYDROPHOBIC RECOVERY AGENT REGENERATION

(71) Applicant: Magna Imperio Systems Corp., Houston, TX (US)

(72) Inventors: Jeremy A. WILLMAN, Tomball, TX (US); Ethan L. DEMETER, The Woodlands, TX (US)

(73) Assignee: Magna Imperio Systems Corp., Houston, TX (US)

(21) Appl. No.: 17/824,116

(22) Filed: May 25, 2022

Related U.S. Application Data
(60) Provisional application No. 63/195,474, filed on Jun. 1, 2021.

(51) Int. Cl. C02F 9/00

(52) U.S. Cl. CPC C02F 9/00; C02F 2001/5218

(57) ABSTRACT

Provided are direct solvent contact crystallization devices and methods. A direct solvent contact crystallization device can comprises a first liquid-liquid separator comprising an inlet stream comprising 10-35 wt. % salt and a first outlet stream comprising water and a solvent; a second liquid-liquid separator comprising an inlet stream comprising the first outlet stream of the first liquid-liquid separator and a first outlet stream comprising 95 wt. % or greater water; and a separation unit comprising an inlet stream comprising a second outlet stream of the second liquid-liquid separator, a first outlet stream comprising the solvent, and a second outlet stream comprising a recovery agent, wherein the inlet stream of the first liquid-liquid separator comprises the first outlet stream of the separation unit, and the inlet stream of the second liquid-liquid separator comprises the second outlet stream of the separation unit.

### REFERENCE TO RELATED APPLICATIONS

This application claims the benefit of U.S. Provisional Application No. 63/195,474, filed Jun. 1, 2021, the entire contents of which are incorporated herein by reference.

### FIELD

The present disclosure relates to desalination methods and processes. Specifically, the present disclosure relates to zero-liquid discharge processes and brine concentration that includes a multi-stage process of treating brine with a solvent to remove the salt, and then treating with a recovery agent to recover the water.

### BACKGROUND

Zero-liquid discharge (ZLD) describes a desalination process whereby all the treated water is recovered as freshwater and only solid salts are produced as a byproduct, resulting in minimal waste. Conventional ZLD processes implement existing technologies to sequentially process water along a concentration gradient, necessarily passing the water to more energy-intensive separation processes as the salt content increases. Thus, the energy requirement for treating a volume of water to ZLD is a function of the initial concentration, with the later stages requiring much of the total energy for the process. The final stages of these processes are usually thermally-driven and crystallize solid salts from saturated or supersaturated brines. While thermal desalination processes have seen intensive engineering optimization to achieve higher energy efficiencies via scrupulous recycling of latent heats of transformation, these processes are still inherently energy intensive due to thermodynamic limits (Carnot efficiencies and work requirement for the several changes of state.)

Alternative processes to existing technologies have been proposed that utilize a solvent or working fluid to selectively extract water from concentrated brines. In these processes, commonly known as directional solvent extraction (DSE), temperature swing solvent extraction (TSSE), or solvent extraction desalination (SED) water-salt separations are performed by variable molecular interactions and are not governed by thermal efficiency limits. However, the water-salt interactions are consequently replaced by solvent-water interactions, which must be overcome to recover freshwater. Overcoming the produced solvent-water interactions can be achieved through a variety of physical or chemical processes but is most commonly performed by a simple temperature change. The clear advantage of such processes is that no physical change of state occurs for the separated water which would incur an inherent energy penalty.

### SUMMARY

Provided herein are direct solvent contact crystallization (DSCC) processes and methods for desalinating water. Conventional water desalination processes, such as directional solvent extraction (DSE), temperature swing solvent extraction (TSSE), or solvent extraction desalination (SED) described above, include inefficient solvent-water thermal separation and can be quite energy intensive. However, the direct solvent contact crystallization processes and methods provided herein separate water from a salt-water solution by first allowing the water to bind to a solvent to form a water-solvent solution, and then allowing the solvent to bind with a recovery agent to remove the solvent from the water-solvent solution, resulting in a desalinated water product. These processes and methods provided herein can be more efficient than the salt-water or solvent-water separation of conventional thermal separation processes due to the narrower operating temperature range and low heat penalty for the phase change of the recovery agent in comparison to that of water. Further, the separation of the volatile recovery agent from the non-volatile solvent allows for the convenient use of pressure changes to modify the separation conditions and phase change heat penalty. Finally, another major advantage of such a process is that it can replace the entire latter, energy intensive, portion of traditional ZLD treatment train; the DSCC process can treat naturally concentrated or pre-concentrated brines (>10 wt %) to solid salt and freshwater.

The DSCC processes and methods provided herein utilize a three-stage separation process. First, water is selectively absorbed from brine into a non-volatile solvent system. Then, a volatile hydrophobic recovery agent is added to the solvent-water mixture, releasing the freshwater product. Finally, the solvent-recovery agent mixture is transferred to separation process, where the pure solvent and recovery agent can be recovered.

The first stage of DSCC processes and methods provided herein includes removing water from brine with a solvent. In the presence of certain solvents, water has a stronger affinity for the solvent than the salt of the brine. Thus, when the brine is mixed with the solvent, the water of the brine will bond to the solvent. This first stage may utilize a liquid-liquid separation unit (e.g., crystallizer, brine concentrator). The inputs to the liquid-liquid separation unit include brine and a solvent, and the outputs include salt and a water-solvent solution.

The second stage of DSCC processes and methods provided herein includes mixing the water-solvent solution of the first stage with a recovery agent. In the presence of certain recovery agents, the water of the water-solvent solution has a stronger affinity for the recovery agent than it does the solvent. Thus, when the water-solvent solution is mixed with the recovery agent, the water and solvent will separate, allowing the water to bond to the recovery agent. This second stage may also utilize a liquid-liquid separation unit. The inputs to the liquid-liquid separation unit of the second stage may include the water-solvent solution of the first stage and a recovery agent, and the outputs may include the water and a solvent-recovery agent solution.

The third stage of DSCC processes and methods provided herein includes recovering solvent and recovery agent of the solvent-recovery agent solution. In some embodiments, a reflux or distillation column may be used to separate the recovery agent and solvent from each other. Each component (recovery agent, solvent) may be recycled. For example, the recovery agent may be recycled back into stage 2 of the DSCC process, and the solvent may be recycled back into stage 1 of the DSCC process.

In some embodiments, provided is a direct solvent contact crystallization device, the device comprising: a first liquid-liquid separator, the first liquid-liquid separator comprising an inlet stream, a first outlet stream and a second outlet stream, wherein the inlet stream comprises 10-35 wt. % salt and the first outlet stream comprises water and a solvent; a second liquid-liquid separator, the second liquid-liquid separator comprising an inlet stream, a first outlet stream, and a second outlet stream, wherein the inlet stream comprises the first outlet stream of the first liquid-liquid separator and the first outlet stream comprises 90 wt. % or greater water; and a separation unit, the separation unit comprising an inlet stream, a first outlet stream, and a second outlet stream, wherein the inlet stream comprises the second outlet stream of the second liquid-liquid separator, the first outlet stream comprises the solvent, and the second outlet stream comprises a recovery agent, wherein the inlet stream of the first liquid-liquid separator comprises the first outlet stream of the separation unit, and the inlet stream of the second liquid-liquid separator comprises the second outlet stream of the separation unit.

In some embodiments of the device, the first liquid-liquid separator is a crystallizer or brine concentrator.

In some embodiments of the device, the salt is a salt of sodium, potassium, calcium, magnesium, bromide, chloride, or iodide.

In some embodiments of the device, the solvent comprises primary and secondary amines.

In some embodiments of the device, the solvent comprises 10-80 wt. % primary amines, 0-80 wt. % secondary amines, 0-80 wt. % tertiary amines, and 0-30 wt. % recovery agent.

In some embodiments of the device, the recovery agent comprises one of butane, propane, ethane, pentane, diethyl ether, or dichloromethane.

In some embodiments of the device, the second liquid-liquid separator is configured to heat the inlet stream to a temperature of 40-90° C.

In some embodiments of the device, the separation unit is a distillation column or a flash drum.

In some embodiments, a method of desalinating water is provided, the method comprising: passing an inlet stream through a first liquid-liquid separator to produce a first outlet stream and a second outlet stream, wherein the inlet stream comprises 10-35 wt. % salt and the first outlet stream comprises water and a solvent; routing the first outlet stream of the first liquid-liquid separator through a second liquid-liquid separator comprising an inlet stream to produce a first outlet stream and a second outlet stream, wherein the inlet stream comprises the first outlet stream of the first liquid-liquid separator and the first outlet stream comprises 90 wt. % or greater water; and routing the second outlet stream of the second liquid-liquid separator through a separation unit comprising an inlet stream to produce a first outlet stream and a second outlet stream, wherein the inlet stream comprises the second outlet stream of the second liquid-liquid separator, the first outlet stream comprises the solvent, and the second outlet stream comprises a recovery agent, wherein the inlet stream of the first liquid-liquid separator comprises the first outlet stream of the separation unit, and the inlet stream of the second liquid-liquid separator comprises the second outlet stream of the separation unit.

In some embodiments of the method, the first liquid-liquid separator is a crystallizer or brine concentrator.

In some embodiments of the method, the salt is a salt of sodium, potassium, calcium, magnesium, bromide, chloride, or iodide.

In some embodiments of the method, the solvent comprises primary amines, secondary amines, tertiary amines, and the recovery agent.

In some embodiments of the method, the solvent comprises 10-80 wt. % primary amines, 0-80 wt. % secondary amines, 0-80 wt. % tertiary amines, and 0-30 wt. % recovery agent.

In some embodiments of the method, the recovery agent comprises one of butane, propane, ethane, pentane, diethyl ether, or dichloromethane.

In some embodiments of the method, the second liquid-liquid separator is configured to heat the inlet stream to a temperature of 40-90° C.

In some embodiments of the method, the separation unit is a distillation column or a flash drum.

In some embodiments, any one or more of the features, characteristics, or elements discussed above with respect to any of the embodiments may be incorporated into any of the other embodiments mentioned above or described elsewhere herein.

### BRIEF DESCRIPTION OF THE FIGURES

This application contains at least one drawing executed in color. Copies of this patent application publication with color drawing(s) will be provided by the Office upon request and payment of the necessary fee.

FIG. 1A shows double-ternary phase diagram for the sequential separation of salt (NaCl) from water in the stage 1, followed by water from solvent stage 2;

FIG. 1B shows improved water separation efficiency with heating in stage 2;

FIG. 2 shows a vapor-liquid equilibrium (VLE) diagram for the separation of the water-lean Solvent-RA mixture (J) in stage 3;

FIG. 3 shows a process diagram of a direct solvent contact crystallization process, according to some embodiments; and

FIG. 4 shows a direct solvent contact crystallization method, according to some embodiments.

### DETAILED DESCRIPTION

Described herein are direct solvent contact crystallization (DSCC) processes and methods for recovering water from brine. DSCC processes and methods utilize a solvent blend that can selectively absorb water from brine while rejecting salt. The brine thus becomes concentrated, reaching up to and beyond saturation, resulting in the precipitation of a solid salt. Relative to conventional desalination processes such as directional solvent extraction, temperature swing solvent extraction, and/or solvent extraction desalination, the processes and methods provided herein can recover water from brine more efficiently with less energy than conventional separation processes. The DSCC processes and methods provided herein can include three separate stages.

In a first stage, brine is mixed with a solvent. The solvent used is specially selected such that the water of the brine has a greater affinity for the solvent than it does the salt of the brine. When the brine is mixed with the solvent, the salt will separate from the water and the water will bind to the solvent. This reaction can generate salt as a waste product and a water-solvent solution as a product or outlet stream.

In a second stage, the water-solvent solution is mixed with a recovery agent. The solvent of the water-solvent solution has a stronger affinity for the recovery agent than it does the water. Thus, when the water-solvent solution is mixed with the recovery agent, the solvent will dissociate from the water and bind to the recovery agent. This will create a product stream of water and an outlet stream of a solvent-recovery agent solution.

In a third stage, the solvent and recovery agent of the solvent-recovery agent solution may be recovered and recycled. For example, the solvent may be recycled back into the first stage of a DSCC process. The recovery agent may be recycled back into a second stage of a DSCC process.

Described below are DSCC processes and methods for recovering water from brine, and in particular, each stage of DSCC processes provided herein are described in detail.

### Stage One: Crystallization/Brine Concentration

Stage one of DSCC processes described herein can include separating a salt from a brine-solvent solution to achieve a salt waste and a water-solvent solution. In some embodiments, the salt waste may comprise crystallized solids or a concentrated brine. Thus, the separation unit of this first stage may comprise a crystallizer or a brine concentrator.

Specifically, the first stage of DSCC processes provided herein utilizes a solvent blend that can selectively absorb water from brine while rejecting salt. The brine thus becomes concentrated, reaching up to and beyond saturation, resulting in the precipitation solid salt. Solvent blends of primary (1º) amines, secondary (2º) amines, tertiary (3º) amines, carboxylic acids (CA), liquid polyether polymer solutions, and/or certain ionic liquids are known to fulfill this selectivity requirement. The solubility of water in these solvent blends is dependent on temperature, with increasing temperature resulting in lower water solubilities. Previous inventions have relied on the changes in solubility over a temperature swing cycle to perform water absorption at low temperatures (5-20 ° C.) and water recovery at high temperatures (40-90 ° C.). While this mechanism can be used to desalinate water, much of the absorbed water remains in the solvent and is not recovered each cycle. This results in large amounts of solvent being required to treat small amounts of brine (e.g. 35:1 w/w % solvent:product water ratios) which translates to poor process efficiencies.

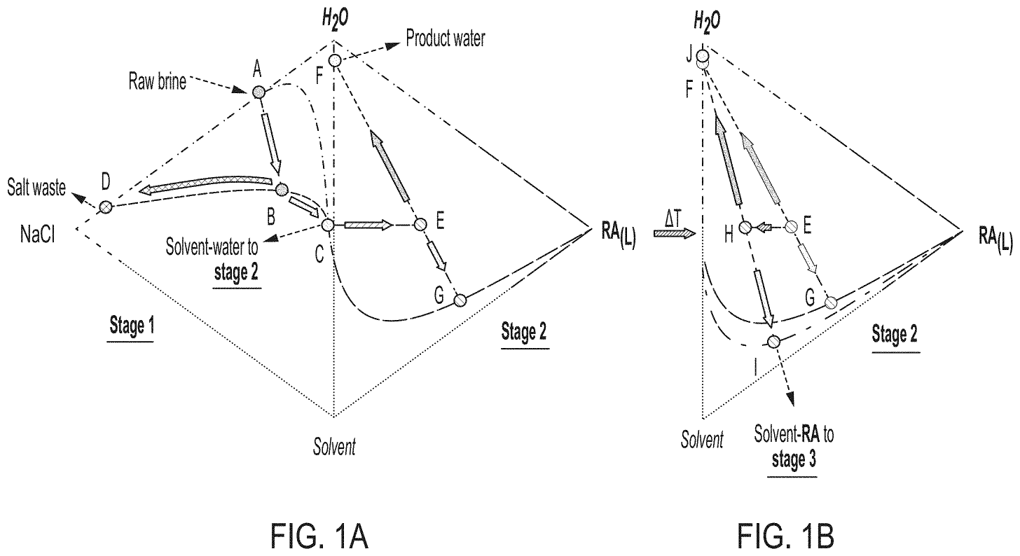

FIG. 1A shows a double-ternary phase diagram for the sequential separation of salt (NaCl) from water in the first stage of a DSCC process, according to some embodiments, followed by the separation of water from solvent in stage two of a DSCC process, according to some embodiments. As shown in FIG. 1A, “A” represents the phase of an incoming raw brine composition. In some embodiments, the incoming raw brine composition may comprise 1-35 wt. % salt. In some embodiments, the incoming raw brine composition may comprise less than or equal to 35, 30, 25, 20, 15, 10, or 5 wt. % salt. In some embodiments, the incoming raw brine composition may comprise more than or equal to 1, 5, 10, 15, 20, 25, or 30 wt. % salt. In some embodiments, the incoming raw brine composition comprises ≤35wt. % salt. In some embodiments, the salt compound is a simple salt, including, but not limited to, sodium chloride, calcium carbonate, sodium acetate, sodium sulfide, sodium carbonate, sodium bisulfate, etc. In some embodiments, the salt compound may comprise a salt of sodium, potassium, calcium, magnesium, bromide, chloride, iodide, or the like. In some embodiments, the salt compound may comprise a Group I or a Group II halide.

“AB” represents adding a solvent to the brine. “B” represents the phase of the salt-water-solvent mixture once the solvent has been added. In some embodiments, the solvent blend may comprise one or more primary (1º) amine, secondary (2º) amines, tertiary (3º) amines, carboxylic acids (CA), liquid polyether polymer solutions, and/or carboxylic acids. In some embodiments, the solvent blend may further comprise some recovery agent. The “B” stream may comprise some recovery agent because it may not be fully separated from the solvent during stage three (separation). A perfect separation of the solvent and recovery agent at stage three would require a greater amount of energy, more equipment, etc. Additionally, the presence of some recovery agent in the solvent blend can prevent emulsification of the solvent-water mixture in stage one.

In some embodiments, the solvent blend may comprise 10-80 wt. % primary amines. In some embodiments, the solvent blend may comprise less than or equal to 80, 75, 70, 65, 60, 55, 50, 45, 40, 35, 30, 25, 20, or 15 wt. % primary amines In some embodiments, the solvent blend may comprise more than or equal to 10, 15, 20, 23, 30, 35, 40, 45, 50, 55, 60, 65, 70, or 75 wt. % primary amines In some embodiments, the solvent blend may comprise 0-80 wt. % secondary amines. In some embodiments, the solvent blend may comprise less than or equal to 80, 75, 70, 65, 60, 55, 50, 45, 40, 35, 30, 25, 20, 15, 10, or 5 wt. % secondary amines In some embodiments, the solvent blend may comprise more than or equal to 0, 5, 10, 15, 20, 25, 30, 35, 40, 45, 50, or 55 wt. % secondary amines. In some embodiments, the solvent blend may comprise 0-80 wt. % tertiary amines In some embodiments, the solvent blend may comprise less than or equal to 80, 75, 70, 65, 60, 55, 50, 45, 40, 35, 30, 25, 20, 15, 10, or 5 wt. % tertiary amines In some embodiments, the solvent blend may comprise more than or equal to 0, 5, 10, 15, 20, 25, 30, 35, 40, 45, 50, or 55 wt. % tertiary amines In some embodiments, the solvent blend may comprise 0-30 wt. % recovery agent. In some embodiments, the solvent blend comprises less than or equal 30, 25, 20, 15, 10, 5, or 1 wt. % recovery agent. In some embodiments, the solvent blend comprises more than or equal to 0, 0.5, 1, 5, 10, 15, 20, or 25 wt. % recovery agent.

“BD” represents the precipitation of a solid hydrated salt in a liquid-liquid separator (e.g., crystallizer, brine concentrator). “D” represents the composition of hydrated crystal salt (e.g., NaCl) slurry (sent to solid waste). “BC” represents water absorbed into solvent phase. “C” represents the composition of hydrated solvent phase (sent to water recovery at stage two). In some embodiments, the hydrated solvent phase (that is sent to water recovery at stage two) may comprise 1-50 wt. % water. In some embodiments, the hydrated solvent phase may comprise less than or equal to 50, 45, 40, 35, 30, 25, 20, 15, 10, or 5 wt. % water. In some embodiments, the hydrated solvent phase may comprise more than or equal to 1, 5, 10, 15, 20, 25, 30, 35, 40, or 45 wt. % water.

### Stage Two: Recovering Water

In a second stage of DSCC processes provided herein, a volatile hydrophobic recovery agent (RA) is added to the water-solvent solution. The addition of the recovery agent results in the rejection of the absorbed water from the organic phase. The recovery agent must be miscible with the solvent blend and sufficiently hydrophobic to reject the absorbed water. Additionally, the recovery agent must also have a large relative difference in volatility from the solvent blend, such that it can be readily separated in a distillation process. Suitable compounds to be used as the recovery agent can include volatile alkanes such as ethane, butane, propane, pentane, etc. in the liquid state as well as many refrigerants such as fluoroethane and other halocarbons and volatile organic compounds such as ethyl methylether, diethyl ether, carbon disulfide, dimethyl sulfide, methanethiol, dichloromethane, chloroethane, and chloromethane. Once the desalinated water has been rejected from the solvent by the recovery agent, the solvent-recovery agent mixture can be sent to a separation apparatus to be separated based to their differences in volatility (i.e., stage three).

FIG. 1A shows a double-ternary phase diagram for the sequential separation of salt (NaCl) from water in the first stage of a DSCC process, according to some embodiments, followed by the separation of water from solvent in stage two of a DSCC process, according to some embodiments. The first stage of FIG. 1A is described above. For stage two of FIG. 1B, “CE” represents the addition of liquified recovery agent (RA_{(L)}) to hydrated solvent from stage 1 (“C”). “E” represents the composition of Water-Solvent-RA_{(L)} mixture after liquified RA_{(L)} addition. “G” represents the composition of the organic-rich phase. “EF” represents the phase separation of aqueous phase (F) from organic-rich phase (G). “F” is the composition of the aqueous phase. In some embodiments, the aqueous phase comprises 80-99.9 wt. % water. In some embodiments, the aqueous phase comprises less than or equal to 99.9, 99.9, 99.5, 99, 98, 95, 90, or 85 wt. % water. In some embodiments, the aqueous phase comprises more than or equal to 80, 85, 90, 85, 98, 99, 99.5, or 99.8 wt. % water. “EG” is the phase separation of the organic-rich phase (G) from the aqueous phase (F).

FIG. 1B shows that heating during stage two can improve the water separation efficiency, according to some embodiments. “ΔT” represents heated separation of water-solvent-RA_{(L)} mixture. In some embodiments, the mixture may be heated to a temperature of 10 to 100° C. In some embodiments, the mixture may be heated to a temperature of less than or equal to 100, 90, 80, 70, 60, 50, 40, 30, or 20° C. In some embodiments, the mixture may be heated to a temperature of more than or equal to 10, 20, 30, 40, 50, 60, 70, 80, or 90° C.

“EH” represents reduced RA_{(L)} composition of heated water-solvent-RA_{(L)} mixture. “H” represents the composition of heated water-solvent-RA_{(L)} mixture. “I” represents the composition of heated organic-rich phase (water-lean solvent-RA_{(L)} mixture sent to separation recycle of stage three). In some embodiments, the water-lean solvent-RA_{(L)} mixture (for stage three) may comprise 0.1-20 wt. % water. In some embodiments, the water-lean solvent-RA_{(L)} mixture may comprise less than or equal to 20, 15, 10, 5, or 1 wt. % water. In some embodiments, the water-lean solvent-RA_{(L)} mixture may comprise more than or equal to 0.1, 1, 5, 10, or 15 wt. % water. In some embodiments, the water-lean solvent-RA_{(L)} mixture may comprise 10-40 wt. % recovery agent. In some embodiments, the water-lean solvent-RA_{(L)} mixture comprises less than or equal to 40, 35, 30, 25, 20, or 15 wt. % recovery agent. In some embodiments, the water-lean solvent-RA_{(L)} mixture comprises more than or equal to 10, 15, 20, 25, 30, or 35 wt. % recovery agent. In some embodiments, the water-lean solvent-RA_{(L)} mixture comprises 50-90 wt. % solvent. In some embodiments, the water-lean solvent-RA_{(L)} mixture comprises less than or equal to 90, 85, 80, 75, 70, 65, 60, or 55 wt. % solvent. In some embodiments, the water-lean solvent-RA_{(L)} mixture comprises more than or equal to 50, 55, 60, 65, 70, 75, 80, or 85 wt. % solvent.

“J” represents the composition of heated aqueous phase (desalinated product water sent to further purification stages if required). In some embodiments, the heated aqueous phase may comprise 0.1-20 wt. % salt solution. In some embodiments, the heated aqueous phase may comprise less than or equal to 20, 15, 10, 5, or 1 wt. % salt solution. In some embodiments, the heated aqueous phase may comprise more than or equal to 0.1, 1, 5, 10, or 15 wt. % salt solution. In some embodiments, the salt solution of the heated aqueous phase may comprise 7% water recovery and 80% salt rejection. In some embodiments, the heated aqueous phase may comprise 80-99.9 wt. % water. In some embodiments, the heated aqueous phase may comprise less than or question to 99.9, 99, 98, 95, 90, or 85 wt. % water. In some embodiments, the heated aqueous phase may comprise more than or equal to 80, 85, 90, 95, 98, or 99 wt. % water. “HI” represents the phase separation of heated organic-rich phase (I) from aqueous phase (J). “HJ” represents the phase separation of heated aqueous phase (J) from organic-rich phase (I).

### Stage Three: Recovering Solvent and Recovery Agent

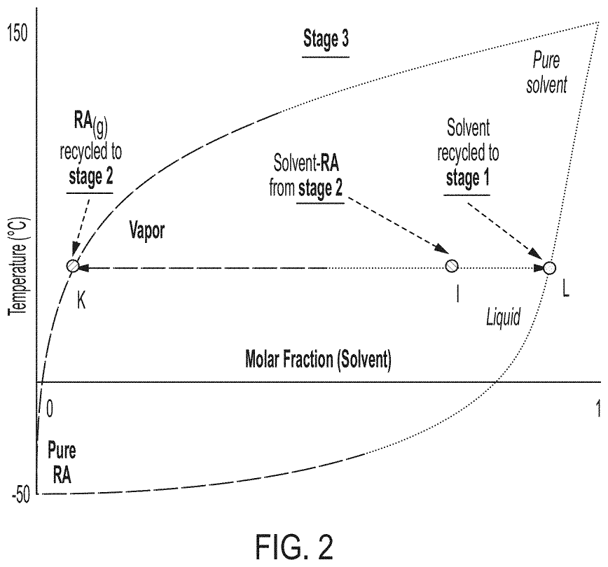

FIG. 2 shows a vapor-liquid equilibrium (VLE) diagram for the separation of the water-lean solvent-recovery agent mixture (J) in stage three of a DSCC process, according to some embodiments.

As shown in FIG. 2, “I” represents the incoming water-lean solvent-RA_{(L)} mixture from stage two. “IK” represents vaporization of volatile RA_{(L)} to vapor (RA_{(g)}) in the reboiler. “K” represents the composition of the vaporized RA_{(g)} leaving the top of the separation unit. In some embodiments, the vaporized RA_{(g)} stream may comprise 80-99.9 recovery agent. In some embodiments, the vaporized RA_{(g)} stream may comprise less than or equal to 99.9, 99, 95, 90, or 85 wt. % recovery agent. In some embodiments, the vaporized RA_{(g)} stream may comprise more than or equal to 80, 85, 90, 95, or 99 wt. % recovery agent. In some embodiments, the vaporized RA may be recycled and reused in stage two. “IL” represents the concentration of the solvent in the bottoms of the separation unit. “L” represents the composition of the recycled solvent bottoms. In some embodiments, the recycled solvent stream may comprise 70-99 wt. % solvent. In some embodiments, the recycled solvent stream may comprise less than or equal to 99, 95, 90, 85, 80, 75 wt. % solvent. In some embodiments, the recycled solvent stream may comprise more than or equal to 70, 75, 80, 85, 90, or 95 wt. % solvent. In some embodiments, the solvent “L” may be recycled back into stage one.

### DSCC Devices and Processes

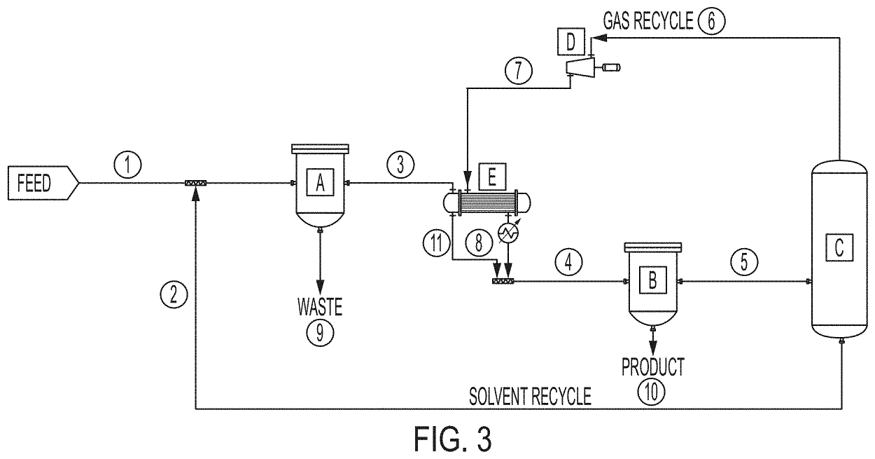

FIG. 3 shows a process 300 for desalinating water, according to some embodiments. As described herein, the process of FIG. 3 includes three units or stages—a first liquid-liquid separator 302 of a first stage, a second liquid-liquid separator 304 of a second stage, and a separation unit 306 of a third stage.

Inlet stream 322 is fed into first liquid-liquid separator 302. Inlet stream 322 comprises feed stream 320. In some embodiments, inlet stream 322 also comprises stream 334. Stream 334 is a first outlet stream of separation unit 306. First outlet stream 334 comprises solvent, and may be recycled back into first liquid-liquid separator 302. Feed stream 320 comprises brine. Feed stream 320 may have the composition of “A” described above with reference to FIG. 1A. Stream 322 may have the composition of “B” as described above with reference to FIG. 1A.

First liquid-liquid separator 302 separates the salt from inlet stream 322 to form a first outlet stream 326 and a second outlet stream 324. The first outlet stream 326 comprises salt, and may have the composition of “D” are described about with reference to FIG. 1A. The second outlet stream 324 may comprise water and solvent, and may have the composition of stream “C” as described above with reference to FIG. 1A.

The first outlet stream 326 of the first liquid-liquid separator 302 is routed to a second liquid-liquid separator 304. The second liquid-liquid separator 304 is configured to recover water from the inlet stream (comprising first outlet stream 326). The first outlet stream 330 comprises the recovered water and can have the composition of “F” as described above with reference to FIG. 1A. The second outlet stream 332 comprises solvent and recovery agent and can have the composition of stream “I” as described above with reference to FIG. 1B. In some embodiments, the second liquid-liquid separator 304 may be configured to heat the inlet stream (comprising the first outlet stream 326 of the first liquid-liquid separator 302). Heating can improve the water separation efficiency, according to some embodiments. In some embodiments, the mixture may be heated to a temperature of 10 to 100° C. In some embodiments, the mixture may be heated to a temperature of less than or equal to 100, 90, 80, 70, 60, 50, 40, 30, or 20° C. In some embodiments, the mixture may be heated to a temperature of more than or equal to 10, 20, 30, 40, 50, 60, 70, 80, or 90° C.

The second outlet stream 332 may be routed to a separation unit 306. Separation unit 306 may include a separation vessel such as a distillation column or a flash drum, and may be configured to separate the solvent from the recovery agent of the inlet stream (comprising the second outlet stream 332 of the second liquid-liquid separator 304). A first outlet stream 334 comprises the solvent and a second outlet stream 336 comprises the recovery agent. The first outlet stream 334 may have the composition of “L” as described with respect to FIG. 2. The second outlet stream 336 may have the composition of “K” as described above with respect to FIG. 2. In some embodiments, first outlet stream 334 may be recycled such that the inlet stream 322 of the first liquid-liquid separator 302 comprises first outlet stream 334. In some embodiments, second outlet stream 336 may be recycled such that the inlet stream 328 of the second liquid-liquid separator 304 comprises the second outlet stream 336.

In some embodiments, the second outlet stream 336 may be passed through a compressor 308. In some embodiments, the second stream 336 may be passed through an (air/water) heat exchanger 310. In some embodiments, process 300 may include only one of the compressor 308 or heat exchanger 310. In some embodiments, the heat exchanger 310 may be located before the compressor 308. In some embodiments, process 300 may not include compressor 308 nor heat exchanger 310. For example, the volatility of the recovery agent (e.g., butane, propane) may determine whether a compressor 308 and/or a heat exchanger 310 are used. In some embodiments, for a less volatile recovery agent, compressor 308 may not be needed. In some embodiments, a less volatile recovery agent may need a reboiler in separation unit 306. In some embodiments, a less volatile recovery agent may need an external (air/water) heat exchanger, such as that of heat exchanger 310.

In some embodiments, the volatility of the RA may also determine whether first outlet stream 334 should be routed through a compressor and/or a heat exchanger. For example, a less volatile RA may necessitate the use of an external (air/water) heat exchanger prior to being recycled back in to the first liquid-liquid separator 302.

Methods of Desalinating Water Using a DSCC Process

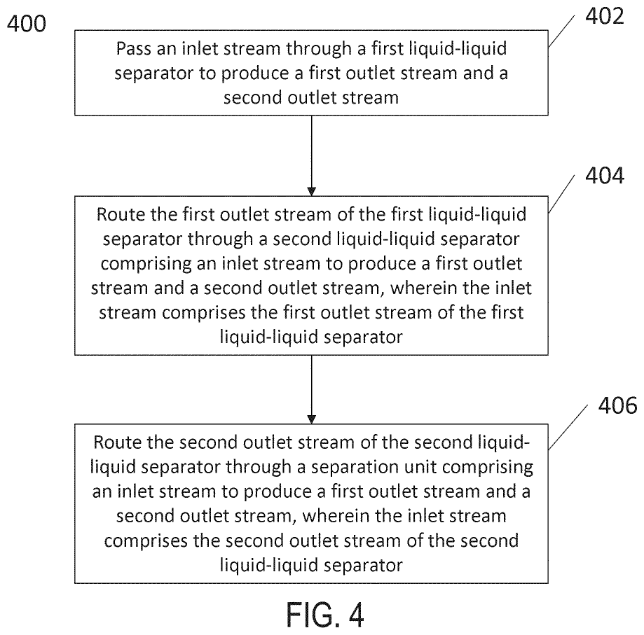

FIG. 4 shows a method 400 for desalinating water, according to some embodiments provided herein.

At step 402, an inlet stream is passed through a first liquid-liquid separator (e.g., the liquid-liquid separator of the first stage) to produce a first outlet stream and a second outlet stream. In some embodiments, the inlet stream comprises 10-26 wt. % salt. In some embodiments, the first outlet stream comprises water and a solvent.

At step 404, the first outlet stream of the first liquid-liquid separator of step 402 is routed through a second liquid-liquid separator (e.g., the liquid-liquid separator of the second stage) comprising an inlet stream to produce a first outlet stream and a second outlet stream. The inlet stream of the second liquid-liquid separator comprises the first outlet stream of the first liquid-liquid separator. In some embodiments, the first outlet stream comprises 90 wt. % or greater water. In some embodiments, the second outlet stream comprises a solvent and a recovery agent.

At step 406, the second outlet stream of the second liquid-liquid separator is routed through a separation unit (e.g., of the third stage) comprising an inlet stream to produce a first outlet stream and a second outlet stream. The inlet stream comprises the second outlet stream of the second liquid-liquid separator. In some embodiments, the first outlet stream comprises the solvent. In some embodiments, the second outlet stream comprises a recovery agent.

Additionally, in some embodiments, the inlet stream of the first liquid-liquid separator comprises the first outlet stream of the separation unit. In some embodiments, the inlet stream of the second liquid-liquid separator comprises the second outlet stream of the separation unit.

### EXAMPLES

The disclosure is further illustrated by the following non-limiting example.

A blend of 1º (hexan-1-amine) and 2º (N-Ethyl-n-butylamine) and a small amount of recovery agent (RA) (pentane) (6.3 mL of 63:33:4 2º:1º:RA) was added to a volume of concentrated NaCl brine (2.0 mL 26 wt %) at room temperature (25 ° C.). Some of the water from the brine was absorbed into the solvent blend (˜13 wt %) and solid salt precipitated from the supersaturated solution. The solvent was separated from the salt-water slurry and transferred to another vessel. Table 1, below, shows the compositions of the various components. (“A” represents the phase of an incoming raw brine composition. “AB” represents adding a solvent to the brine. “C” represents the composition of hydrated solvent phase (sent to water recovery at stage two).

TABLE 1
DSCC Stage 1 component compositions

| | Volume A | A | Volume AB | AB | Volume C | C |
|---|---|---|---|---|---|---|
| Component | (mL) | (wt %) | (mL) | (wt %) | (mL) | (wt %) |
| RA | — | — | 0.3 | 4 | 0.3 | 4 |
| 1° amine | — | — | 2.0 | 33 | 2.0 | 29 |
| 2° amine | — | — | 4.0 | 63 | 4.0 | 55 |
| H₂O | 1.8 | 74 | — | — | 0.7 | 13 |
| NaCl | 0.3 | 26 | — | — | 0.0 | 1 |
| Total | 2.0 | 100 | 6.3 | 100 | 7.0 | 100 |

The vessel containing the solvent with absorbed water was heated to 80 ° C. and an amount of RA (2.0 mL) was added, resulting in the formation of an aqueous phase as the majority of the water (approx. 0.4 mL) was recovered from the organic phase. The recovered water had approximately 80% less salt than the starting brine (5 wt. % NaCl). The dried organic phase was separated from the recovered water and transferred to another vessel for distillation. Table 2, below, shows the compositions of the various components.

TABLE 2
DSCC Stage 2 component compositions

| | Volume CE | Mass I | I | Volume J | J |
|---|---|---|---|---|---|
| Component | (mL) | (g) | (wt %) | (mL) | (wt %) |
| RA | 2.0 | 1.3 | 21 | — | — |
| 1° amine | — | 1.5 | 25 | — | — |
| 2° amine | — | 3.0 | 49 | — | — |
| H₂O | — | 0.3 | 5 | 0.4 | 95 |
| NaCl | — | 0.0 | 0 | 0.0 | 5 |
| Total | 2.0 | 6.2 | 100 | 0.4 | 100 |

In the separation process, the volatile RA was vaporized from the solvent mixture and the vapor was collected as a condensed liquid. The condensed RA and concentrated solvent blend can be recycled to repeat the desalination cycle. Table 3, below, shows the compositions of the various components.

TABLE 3
DSCC Stage 3 component compositions

| | Volume K | K | Volume L | L |
|---|---|---|---|---|
| Component | (mL) | (wt %) | (mL) | (wt %) |
| RA | 2.0 | 94 | 0.3 | 4 |
| 1° amine | 0.0 | 1 | 2.0 | 31 |
| 2° amine | 0.0 | 1 | 4.0 | 60 |
| H₂O | 0.1 | 4 | 0.2 | 5 |
| NaCl | 0.0 | 0 | 0.0 | 0 |
| Total | 2.1 | 100 | 6.5 | 100 |

The foregoing description sets forth exemplary systems, methods, techniques, parameters, and the like. It should be recognized, however, that such description is not intended as a limitation on the scope of the present disclosure but is instead provided as a description of exemplary embodiments.

Although the description herein uses terms first, second, etc. to describe various elements, these elements should not be limited by the terms. These terms are only used to distinguish one element from another.

1. A direct solvent contact crystallization device comprising:
a first liquid-liquid separator, the first liquid-liquid separator comprising an inlet stream, a first outlet stream and a second outlet stream, wherein the inlet stream comprises 10-35 wt. % salt and the first outlet stream comprises water and a solvent;
a second liquid-liquid separator, the second liquid-liquid separator comprising an inlet stream, a first outlet stream, and a second outlet stream, wherein the inlet stream comprises the first outlet stream of the first liquid-liquid separator and the first outlet stream comprises 90 wt. % or greater water; and
a separation unit, the separation unit comprising an inlet stream, a first outlet stream, and a second outlet stream, wherein the inlet stream comprises the second outlet stream of the second liquid-liquid separator, the first outlet stream comprises the solvent, and the second outlet stream comprises a recovery agent,
wherein the inlet stream of the first liquid-liquid separator comprises the first outlet stream of the separation unit, and the inlet stream of the second liquid-liquid separator comprises the second outlet stream of the separation unit.

2. The device of claim 1, wherein the first liquid-liquid separator is a crystallizer or brine concentrator.

3. The device of claim 1, wherein the salt is a salt of sodium, potassium, calcium, magnesium, bromide, chloride, or iodide.

4. The device of claim 1, wherein the solvent comprises primary and secondary amines

5. The device of claim 1, wherein the solvent comprises 10-80 wt. % primary amines, 0-80 wt. % secondary amines, 0-80 wt. % tertiary amines, and 0-30 wt. % recovery agent.

6. The device of claim 1, wherein the recovery agent comprises one of butane, propane, ethane, pentane, diethyl ether, or dichloromethane.

7. The device of claim 1, wherein the second liquid-liquid separator is configured to heat the inlet stream to a temperature of 40-90° C.

8. The device of claim 1, wherein the separation unit is a distillation column or a flash drum.

9. A method of desalinating water comprising:
passing an inlet stream through a first liquid-liquid separator to produce a first outlet stream and a second outlet stream, wherein the inlet stream comprises 10-35 wt. % salt and the first outlet stream comprises water and a solvent;
routing the first outlet stream of the first liquid-liquid separator through a second liquid-liquid separator comprising an inlet stream to produce a first outlet stream and a second outlet stream, wherein the inlet stream comprises the first outlet stream of the first liquid-liquid separator and the first outlet stream comprises 90 wt. % or greater water; and
routing the second outlet stream of the second liquid-liquid separator through a separation unit comprising an inlet stream to produce a first outlet stream and a second outlet stream, wherein the inlet stream comprises the second outlet stream of the second liquid-liquid separator, the first outlet stream comprises the solvent, and the second outlet stream comprises a recovery agent,
wherein the inlet stream of the first liquid-liquid separator comprises the first outlet stream of the separation unit, and the inlet stream of the second liquid-liquid separator comprises the second outlet stream of the separation unit.

10. The method of claim 9, wherein the first liquid-liquid separator is a crystallizer or brine concentrator.

11. The method of claim 9, wherein the salt is a salt of sodium, potassium, calcium, magnesium, bromide, chloride, or iodide.

12. The method of claim 9, wherein the solvent comprises primary amines, secondary amines, tertiary amines, and the recovery agent.

13. The method of claim 9, wherein the solvent comprises 10-80 wt. % primary amines, 0-80 wt. % secondary amines, 0-80 wt. % tertiary amines, and 0-30 wt. % recovery agent.

14. The method of claim 9, wherein the recovery agent comprises one of butane, propane, ethane, pentane, diethyl ether, or dichloromethane.

15. The method of claim 9, wherein the second liquid-liquid separator is configured to heat the inlet stream to a temperature of 40-90° C.

16. The method of claim 9, wherein the separation unit is a distillation column or a flash drum.
